(19) United States
(12) Patent Application Publication
(10) Pub. No.: US 2022/0308619 A1
(43) Pub. Date: Sep. 29, 2022

(54) SPHERICAL VOICE CONTROLLED INTELLIGENT PERSONAL ASSISTANT

(71) Applicant: Hillhaven Distribution LLC, St. Petersburg, FL (US)

(72) Inventor: Travis McCarthy, Clearwater, FL (US)

(21) Appl. No.: 17/215,608

(22) Filed: Mar. 29, 2021

(51) Int. Cl. G06F 1/16; G09B 27/08; G10L 15/22

(52) U.S. Cl. CPC G06F 1/1601; G09B 27/08; G10L 15/22; G06F 1/1683; G06F 1/1658; G10L 2015/223

(57) ABSTRACT

An interactive globe or globular virtual assistant has a spherical body shell comprising one or more high resolution LED panels. Within the globe there are microphones and circuitry for accepting voice recognition (commands) and reacting appropriately. Communication circuitry allows communication with networks such as the internet or cellular networks, speakers allow sound as well as visual display. The panels may be touch sensitive so that it may be controlled by soft buttons rather than voice commands, or it may be controlled by an app on a mobile device or a program on a computer, either locally or remotely. It may display almost limitless information, particularly global and map related information.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but reserves all copyright rights whatsoever. 37 CFR 1.71(d).

### CROSS-REFERENCE TO RELATED APPLICATIONS

N/A

### FIELD OF THE INVENTION

This invention relates generally to virtual personal assistants and specifically to an interactive globe-shaped virtual personal assistant.

### STATEMENT REGARDING FEDERALLY FUNDED RESEARCH

This invention was not made under contract with an agency of the US Government, nor by any agency of the US Government.

### BACKGROUND OF THE INVENTION

The modern virtual assistant tends to be a fairly bland shape such as a low cylinder or puck shape, usually because it is designed around a single speaker and is otherwise as compact as possible. Recently, virtual assistants have been made which blend tablet configurations (a flat rectangular screen) with the assistant device. The traditional globe is a static sphere either on a base or in a cage. It usually does not move or change display. It would be advantageous to provide a personal virtual assistant in the form factor of an interactive globe. Attempts have been made in the past to provide interactive globes, but none which were personal web-based interactive voice activated virtual assistants.

FIG. 1 is a PRIOR ART flat screen computer display mounted within some sort of globular housing. This is the best copy available, as it is prior art. It appears to be merely a spherical shell surrounding a computer monitor and thus of little interest. It may be found in U.S. Pat. No. 6,209,846 to Barlow, Apr. 3, 2001.

FIG. 2 is a PRIOR ART block diagram of a computer system with a globe style display as part of the overall system. This is the best copy available, as it is prior art. This device is worth study as it shows a static globe which is computer controlled to move, and has an internal spotlight which shines through the skin of the static globe to highlight one part of the world. This item, U.S. Pat. No. 5,519,809 to Husseiny et al on May 21, 1996 is well worth study even though it lacks:
LED or other screens on the surface of the globe to allow it to display anything, not just the static surface of the Earth
Internal circuitry allowing it to function independently of a computer system
Communication circuitry allowing it to communicate with the internet
Internet based artificial extelligence allowing it to function as a virtual assistant
Internet based artificial extelligence allowing it to function to display material not programmed in previously, that is, to respond to very specific queries like those described in the Summary of the present application.

However, it is not believed that there is any prior art even as close as this item in the patent database. Two other items which are at least somewhat interactive may be found at www.pufferfishdisplays.com and www.youtube.com/watch?v=1NCPY4gBam4 these being more in the nature of interactive globes.

FIG. 3 is a PRIOR ART partially cross-sectional view of a reasonably complex device for globe displays. This is the best copy available, as it is prior art. This device would very accurately display the terminator (light and dark) based upon not just rotation but the actual sidereal day (which accounts for both the 24 hour cycle of rotation of Earth, and also accounts for the fact that the Earth transcribes 1/365.24 of an orbit, which results in the real solar system of an amount of change (1/365.24 of a day) in the length of the day, versus a pure Earth-rotation-only day length. It may be found in U.S. Pat. No. 4,714,351 to Domen, on Dec. 22, 1987.

It would be preferable to provide a colorful and functional virtual assistant, usable with apps designed for a globular display (or with legacy apps designed for flat displays) which doubles as an interactive globe which is able to alter its own surface features.

### SUMMARY OF THE INVENTION

### General Summary

The present invention teaches an interactive globular virtual assistant. The invention has a spherical body shell, which is either covered with high resolution LED panels which are flexible and conform to the surface of the spherical shell or are rigid and make up the shell itself. The invention may have a default setting of appearing to be a globe. This smart sphere will provide an extremely more productive virtual assistant than presently known types.

High resolution LED panels may be Retina® type displays, high density displays, and so forth. The panels may further be touch sensitive, allowing touch control.

The invention is app based, so that it may run apps much like a tablet or other mobile device. In addition, an APK and other development tools may be provided within a complete development environment so that developers, including third party developers, may provide apps specifically designed for use with a spherical three dimensional device such as the invention.

Within the globe there are microphones and circuitry for accepting voice commands by means of voice recognition and reacting appropriately. The voice recognition may occur internally, or by means of communication with a network and an extelligent server which provides the artificial intelligence functions and then returns the appropriate response to the invention, in a manner similar to virtual assistants.

Thus communication circuitry allows communication with networks such as the internet or cellular networks. This may be by means of wifi, Bluetooth®, ethernet, USB connections, Lightning® ports and so on, or by other means now known or later devised. Furthermore, this communication may allow the invention to be controlled by apps on mobile devices or programs on computers located either locally or remotely.

Speakers allow sound output to users as well as visual output. Yet further it could be a simple ball, or it could have a base like a globe, or a cage similar to a globe, or be suspended, and so forth.

Circuitry and parts may be located within the globe or within support structures.

An exemplary list of applications which the assistant could be used with is illuminating as to the wide range of uses for a spherical interactive assistant:
It can do everything that a virtual assistant, home security network or mobile device such as a tablet can do but with spherical or curved features.
The apps the device uses may spin around the sphere as users scrolled them. They can spin in the direction preferred by the user and could have multiple rows of apps for categories of apps, and due to the larger surface area could keep a larger number of apps and display open simultaneously.
Users can surf internet sites and apps and data and it all scrolls in a similar manner. For example, stock market charts and data may spin around the globe or appear to do so.
The device plays music upon request and may display many visuals to accompany the music such as a disco ball appearance, or color animation special effects to sync with the sounds.
Music lists and albums may scroll in a circle around the globe.
It may function to be a nightlight at night and have changes of colors, which could accompany sounds such as white noise, nature sounds, etc.
It could be a spherical lamp upon command at night.
It may create virtual eco-spheres to observe at various scales.
It may have an aquarium view of fish, etc.
A look-in on the universe or galaxy in a sphere shape is another examplary app.
When face-timing or making calls a virtual rolodex of contacts that spins may appear, allowing must faster access to long lists.
Conference calls that have more than 1 person in it may show where they are calling from on a map, the contact location on the globe could be opened for video if they are video conferencing, the graphics would appear and move in a user-friendly manner synced with a globe rotating.
It may show all other planets, such as Jupiter, Mars, Pluto, the Moon, Sun, etc. These can be globes of the objects or star maps or other representations.
It could also function as a touch sensitive virtual plasma ball.
For entertainment, it might serve as an entertaining crystal ball app or magic eight ball app.
Touch screen video game apps may be designed around this spherical display, such as action games to rapidly press soft buttons on a sphere with 2-4 players positioned around it. It might have civilization/planet strategy games to build worlds displayed as globes, and so forth.

However, in addition to such “tech” related services as listed above (video conferencing, games, apps, etc.), it also has many functions tied directly or indirectly to the shape. The invention may display almost limitless information, particularly global and map related information. For example, a user may request the invention to display the earth in night mode (with only city lights and the lights of fishing fleets, fires and flares visible), in day mode, satellite mode (½ of the earth dark and the terminator easily visible in real time), in weather mode (displaying weather at the moment, or in the past or predictions for the future), climate mode (ditto), and so forth. It may display the many thousands of airliners in flight at any given moment, satellites in orbit, the stellar sensorium (astronomical objects visible), a particular year hurricane season in replay, and so forth.

It may also display more human oriented items such as the spread of urban areas, the spread of given political units, electoral college voting patterns, levels of particulate matter in the atmosphere, the travels of Lewis and Clark, the map of Wakanda, and so forth.

It can display natural matters as well: the migration of the Canadian Goose, the path of ocean currents, the natural range of the Screech Owl and so forth.

Thus, over the course of five minutes of intense questioning by a user, and pulling resources straight off the internet, the device might display the extent of the USSR or the Persian Empire or the Mongol Empire, it might display the Continental Divide(s) of a given continent, the drainage basin of the Mississippi River, Australia, the migration of one population of Monarch Butterflies and more.

It could do similar feats for any world: Mars, Barsoom, Westeros, Middle Earth, Narnia, Erehwon and more. It could provide an artificial cut-away or cross-sectional view of Earth's subterranean features.

In addition, it need not remain rigidly confined to a three dimensional globular visual format of data displayed. It may zoom in and thus expand one part of an area, removing other parts of a globe or body and functioning like an extremely curved monitor. It could even correct for viewer parallax in order to create an artificial sensory impression that the spherical display is a round flat display, that is, by increasing the size of items which are disappearing around the arc of the globe to make them appear the same size or shape as items near the middle of the user's view.

Further in addition, it may rotate in two manners. In a first mode it may be actually rotated by means of an optional stepper motor or the like disposed within the globe or a support. In the second mode it may in reality stay still but in display terms rotate what is shown, for example, if a user were to “swipe left” it might rotate the visual globe of the Earth. Obviously, this virtual rotation prevents malfunction of a stepper motor or rotation mechanism and is thus preferable over the optional stepper motor or other mechanical device.

It may be controlled by voice, swipe, multi-touch commands like a pinch, press and hold, tap, stretch, slide to drag, and so forth. These may be used to control the globe features or to control other apps not related to globes. For example, “show me Avalon” or “show me Hollywood stars mansions”.

Once again repeating the exercise of exploring the exemplary applications, but this time focusing on more globe related activities:
A live day/night satellite view of Earth that “rotates” in real time.
Night view only with city lights and northern/southern lights.
Day view only with or without cloud cover. Clouds would dissipate and reform for an aesthetic effect, either simulated clouds or real time.
Large multitude of various globe mode styles and colors, such as found on standard globes in class rooms, including topographic views, ocean floor views, historical geography, prehistoric geography, etc. Animated changes in geography, animated ice cap melting scenarios, etc.
Live weather views in motion. Globe modes which rotate to face user with locations of interest.
Animated historical weather views. Animation of past hurricane seasons, etc. Globe mode rotates to face user for locations of interest.
Current weather/weather forecasts for a given area, or for whole of earth, in satellite view or statistical and graphically informative view, such as gradient color codes, temperature markings, etc. as seen on weather channels/news. Globe mode rotates to face user for locations of interest.
Northern/southern lights visibility forecasts.
Historical animation of empires and important events in history. For example: the old USSR, the Axis and Allies of WWII, the route of Christopher Columbus took, the Louisiana Purchase, the first 13 colonies of the USA, History and animation of the Ottoman empire and roman empire in geographic terms, animation of the population growth of earth. Globe mode rotates to face user for locations of interest.
Current geographical information. Users could for example ask it to “show me” the Mississippi River, the Caspian Sea. The tropic of cancer and capricorn, all Time Zones, The globe mode rotates to face user for locations being discussed.
Graphics of species of animals/plants habitats showing their continents with density color coding.
Graphics/animation of migratory patterns of animals and birds. Globe mode may rotate to face user to show patterns
Graphics/animation of ocean currents.
Graphics/animation of flight path of a specifically named flight number, with take off landing times, etc. with globe rotation animation. Users could ask it “where is Daddy's flight” and then it would display and track it.
Graphics/animation of all flights at a given time.
Application that tracks Santa Clause's global delivery route and where he is in real time and his ETA to your house.
“Scratch maps” with geotagged photos. Scratch maps are maps that show every location a user has been on earth that can be “scratched off” a user's bucket list. Geotagged photos can be marked to every location user has been and the globe mode will spin to an area on command and open the photo upon voice command or touching the tag.
News from around the world can be accessible. Alert tags with news for a given area are visible over a country or city. The news can be touched or commanded to open on screen. The globe mode rotates to show the news. It opens as videos, articles or audio information, with the globe mode as a background to the opened up news window.
On election day, electoral college maps and results can be viewed and zoomed in on by county with percentages of votes per party, etc. Or historical election maps can be pulled up and views.
A global look with animation of the Coronavirus pandemic could be viewed with animation of its timeline of spread and present statistics. The globe mode would rotate for the best/most relevant view of this and would rotate based on questions about specific countries and cities.

### Summary in Reference to Claims

It is therefore another aspect, advantage, objective and embodiment of the invention, in addition to those discussed previously, to provide a spherical voice controlled intelligent personal assistant comprising:

a globular shell having a curved surface;

a support, the globular shell mechanically held by the support so that it may rotate freely upon the support;

the globular shell comprising at least one high resolution LED panel conforming to the curved surface of the globular shell;

a control circuit operative to control the high resolution LED panel, the control circuit also operative to carry out voice recognition, the control circuit responsive to voice recognition;

an external communication connection operative to allow communication from outside the globular shell.

It is therefore another aspect, advantage, objective and embodiment of the invention, in addition to those discussed previously, to provide a spherical voice controlled intelligent personal assistant further comprising:

a second high resolution LED panel, in which the two high resolution LED panels are curved to match the curved surface of the globular shell.

It is therefore another aspect, advantage, objective and embodiment of the invention, in addition to those discussed previously, to provide a spherical voice controlled intelligent personal assistant further comprising:

a second high resolution LED panel, in which the two high resolution LED panels are flexible, and adhered to the curved surface of the globular shell.

It is therefore another aspect, advantage, objective and embodiment of the invention, in addition to those discussed previously, to provide a spherical voice controlled intelligent personal assistant further comprising:

an electrically operated drive mechanism, the electrically operated drive mechanism including a stepper motor operative to respond to commands from the control circuit and rotate the spherical voice controlled intelligent personal assistant precisely.

It is therefore another aspect, advantage, objective and embodiment of the invention, in addition to those discussed previously, to provide a spherical voice controlled intelligent personal assistant wherein the support further comprises:

a base disposed beneath the spherical voice controlled intelligent personal assistant, the base connected to the spherical voice controlled intelligent personal assistant by an axis allowing the precise rotation of the spherical voice controlled intelligent personal assistant.

It is therefore another aspect, advantage, objective and embodiment of the invention, in addition to those discussed previously, to provide a spherical voice controlled intelligent personal assistant wherein the support further comprises:

a suspension system disposed above the spherical voice controlled intelligent personal assistant, the suspension system comprising a rotatable connection to the spherical voice controlled intelligent personal assistant allowing precise rotation of the spherical voice controlled intelligent personal assistant and a thin resilient member in turn connected to the rotatable connection.

It is therefore another aspect, advantage, objective and embodiment of the invention, in addition to those discussed previously, to provide a spherical voice controlled intelligent personal assistant wherein the external communication connection further comprises:

an RF communication module operative to communicate via wife.

It is therefore another aspect, advantage, objective and embodiment of the invention, in addition to those discussed previously, to provide a spherical voice controlled intelligent personal assistant wherein the external communication connection further comprises:

an RF communication module operative to communicate via Bluetooth.

It is therefore another aspect, advantage, objective and embodiment of the invention, in addition to those discussed previously, to provide a spherical voice controlled intelligent personal assistant wherein the external communication connection further comprises:

an RF communication module operative to communicate via cellular telephone network.

It is therefore another aspect, advantage, objective and embodiment of the invention, in addition to those discussed previously, to provide a spherical voice controlled intelligent personal assistant wherein the external communication connection further comprises:

a wired USB communication port.

It is therefore another aspect, advantage, objective and embodiment of the invention, in addition to those discussed previously, to provide a spherical voice controlled intelligent personal assistant wherein the external communication connection further comprises:

a wired Lightning communication port.

It is therefore another aspect, advantage, objective and embodiment of the invention, in addition to those discussed previously, to provide a spherical voice controlled intelligent personal assistant wherein the external communication connection further comprises:

a wired ethernet communication port.

It is therefore another aspect, advantage, objective and embodiment of the invention, in addition to those discussed previously, to provide a spherical voice controlled intelligent personal assistant wherein the external communication connection further comprises:

a wired stereo mini-jack output port.

It is therefore another aspect, advantage, objective and embodiment of the invention, in addition to those discussed previously, to provide a spherical voice controlled intelligent personal assistant wherein the control circuit further is operative to charge the spherical voice controlled intelligent personal assistant via USB charging.

It is therefore another aspect, advantage, objective and embodiment of the invention, in addition to those discussed previously, to provide a spherical voice controlled intelligent personal assistant wherein the control circuit further is operative to power the spherical voice controlled intelligent personal assistant via USB.

It is therefore another aspect, advantage, objective and embodiment of the invention, in addition to those discussed previously, to provide a spherical voice controlled intelligent personal assistant wherein the control circuit further is operative to receive commands from a mobile device, the mobile device having a CPU and memory;

a spherical voice controlled intelligent personal assistant control app residing in the memory of the mobile device.

It is therefore another aspect, advantage, objective and embodiment of the invention, in addition to those discussed previously, to provide a spherical voice controlled intelligent personal assistant wherein the control circuit further is operative to receive commands from a computer, the computer having a CPU and memory;

a spherical voice controlled intelligent personal assistant control app residing in the memory of the computer.

It is therefore another aspect, advantage, objective and embodiment of the invention, in addition to those discussed previously, to provide a spherical voice controlled intelligent personal assistant wherein the control circuit further is operative to receive commands from the computer remotely via a network.

It is therefore another aspect, advantage, objective and embodiment of the invention, in addition to those discussed previously, to provide a spherical voice controlled intelligent personal assistant wherein the control circuit further is operative to access a network in response to the voice recognition.

It is therefore another aspect, advantage, objective and embodiment of the invention, in addition to those discussed previously, to provide a spherical voice controlled intelligent personal assistant wherein the control circuit is further operative to display upon the high resolution LED panels a plurality of soft buttons;

and wherein the high resolution LED panels are touch sensitive and operative to detect activation of a first one of the plurality of soft buttons;

and further wherein the control circuit is operative to respond to activation of the first one of the soft buttons.

It is therefore another advantage, aspect, objective and embodiment of the invention, in addition to those discussed previously, to provide a spherical voice controlled intelligent personal assistant further comprising:

a microphone;

a speaker;

wherein the virtual personal assistant is operative to respond to voice queries and voice commands using voice output and visual display output.

It is therefore another aspect, advantage, objective and embodiment of the invention, in addition to those discussed previously, to provide an electronic personal assistant for use with a network, the electronic personal assistant comprising:

a globular shell having a curved surface;

a support, the globular shell mechanically held by the support so that it may rotate freely upon the support;

the globular shell comprising a plurality of high resolution touch sensitive LED panels conforming to the curved surface of the globular shell;

a control circuit operative to control the high resolution LED panels, the control circuit also operative to carry out voice recognition, the control circuit responsive to voice recognition, the control circuit further operative to display on the high resolution LED panels a plurality of soft buttons, the high resolution LED panels operative to detect activation of a first one of the plurality of soft buttons, the control circuit is operative to respond to activation of the first one of the soft buttons.;

an external communication connection operative to allow communication from outside the globular shell, the external communication connection having an RF communication module operative to communicate via Bluetooth and wife, the external communication connection further having a wired USB port, the control circuit operative to power the electronic personal assistant via USB, the control circuit further operative to access such network in response to voice recognition;

an electrically operated drive mechanism, the electrically operated drive mechanism including a stepper motor operative to respond to commands from the control circuit and rotate the globular shell precisely;

a base disposed beneath the globular shell, the base connected to the globular shell by an axis allowing the precise rotation of the globular shell.

### BRIEF DESCRIPTION OF THE DRAWINGS

FIG. 1 is a PRIOR ART flat screen computer display mounted within some sort of globular housing. This is the best copy available, as it is prior art.

FIG. 2 is a PRIOR ART block diagram of a computer system with a globe style display as part of the overall system. This is the best copy available, as it is prior art.

FIG. 3 is a PRIOR ART partially cross-sectional view of a reasonably complex device for globe displays. This is the best copy available, as it is prior art.

FIG. 4 is a view showing a default setting, one of many possible variant default settings, in which the virtual assistant is doubling as a globe with Australia displayed upon the invention, with additional features visible.

FIG. 5 is a cross-sectional view of the shell of the invention showing only the panels from the inside space within, with other components removed.

FIG. 6 is a block diagram in cross-section of the invention, with the other components still indicated.

FIG. 7 is a block diagram of the electronic control circuitry and communication devices of the present invention.

FIG. 8 is a globe view map of the maximum extent of the Mongol Empire c. 1400, with the extent marked on a contemporary view of the Earth. This view furthermore shows other features of the invention.

FIG. 9 is a zoom view, rather than globe view, of the drainage of the Mississippi River, expanded for maximum detail, and on an alternative embodiment of the invention which is suspended rather than supported from beneath.

FIG. 10 is a zoom view of the migration pattern of the eastern population of Monarch Butterflies, showing how the invention may also utilize touch control of the interface, display and so on. This view is orthographic to the viewer, so that for clarity the display appears to the user to be flat and round rather than spherical.

FIG. 11 is a view of the invention running a more or less conventional app which interfaces with a home security system (such as a Nest, Ring, etc) to show a front doorbell camera view.

FIG. 12 is a view of the invention displaying a financial services app which is actually server based, that is, generated by an internet web site.

FIG. 13 is a view of an embodiment of the invention with no support post depicted and a user engaged in a swipe gesture, from left to right.

### INDEX TO REFERENCE NUMERALS

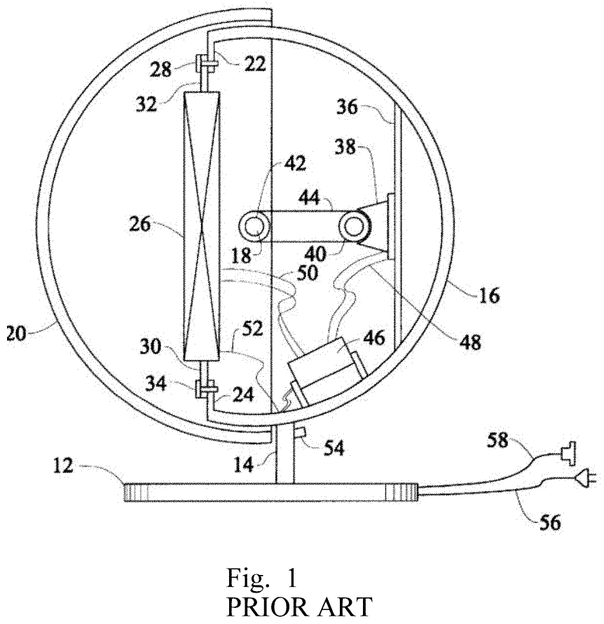

FIGS. 1-3:

The figures are prior art (and the best available images).

The reference numerals in these figures are not used in the application for the present invention and should be ignored.

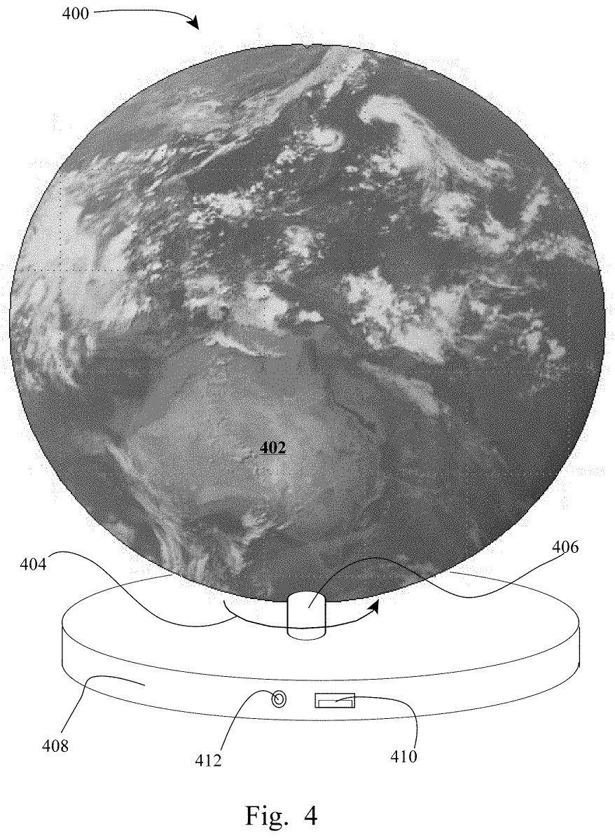

FIG. 4:

Spherical voice controlled intelligent
personal assistant 400
Australia 402
Direction of rotation 404
Support 406
Stand/base 408
USB port 410
Jack 412

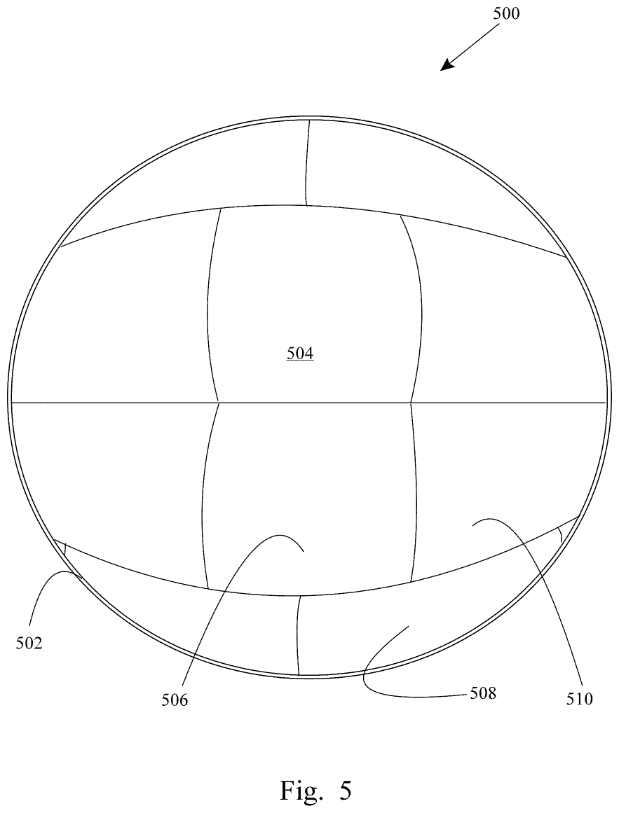

FIG. 5:

Cross-sectioned shell of
globe assistant 500
Shell 502
Interior of globe assistant 504

Individual high quality
display panels 506, 508, 510

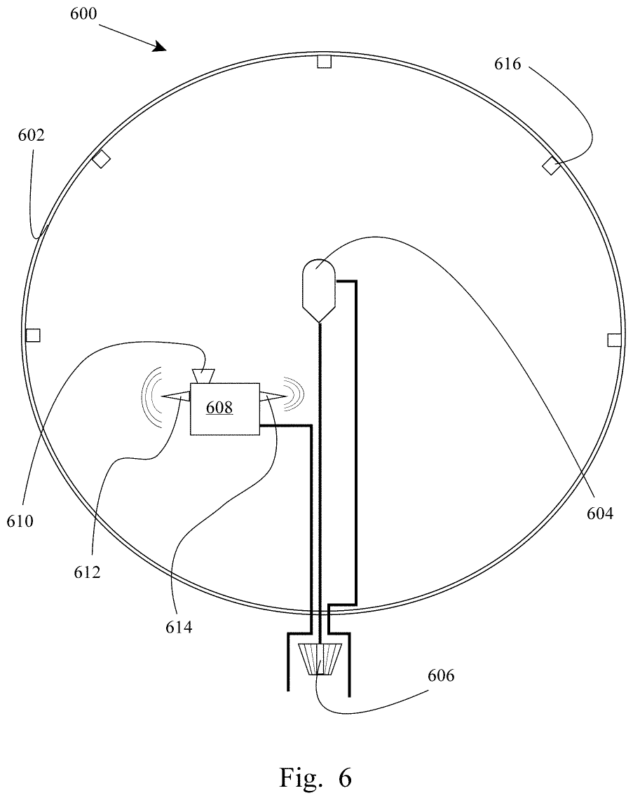

FIG. 6:
Cross-sectioned globe assistant 600
Display shell 602
Stepper motor 604
Drive mechanism 606
Control circuitry 608
Speaker 610
Wifi antenna 612
Bluetooth antenna 614
Microphones 616

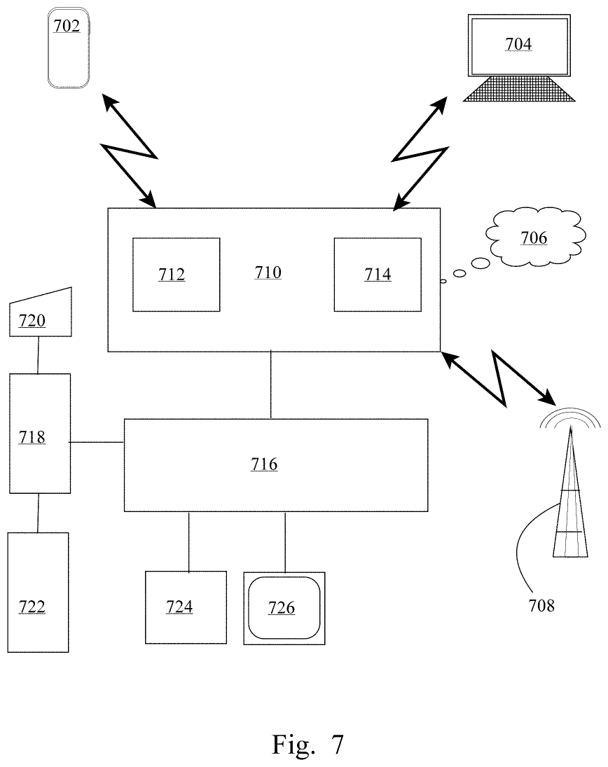

FIG. 7:
Mobile device 702
Computer (PC/server) 704
Network 706
Cellular network 708
Communication module 710
Radio communication module 712
Wired communication module1 714
Graphics controller 716
CPU/RAM 718
Voice recognition/audio in 720
Stepper driver 722
Sound out 724
Display(s) 726

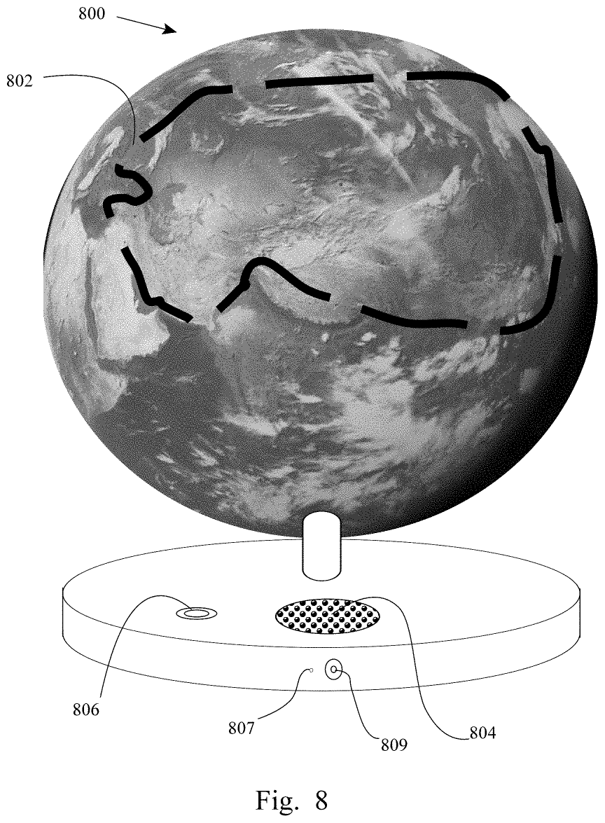

FIG. 8:
Globe assistant 800

Map of maximum extent of
Mongol Empire 802
Base mounted speaker 804
Hard button 806
Microphone 807
Camera 809

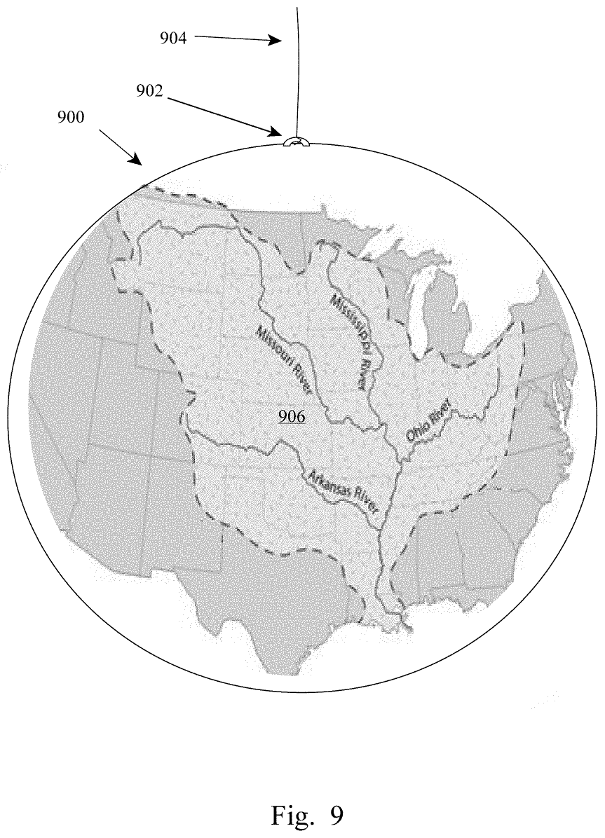

FIG. 9:
Globe assistant 900
Suspension point 902
Suspension 904

Zoomed map of Mississippi
River drainage 906

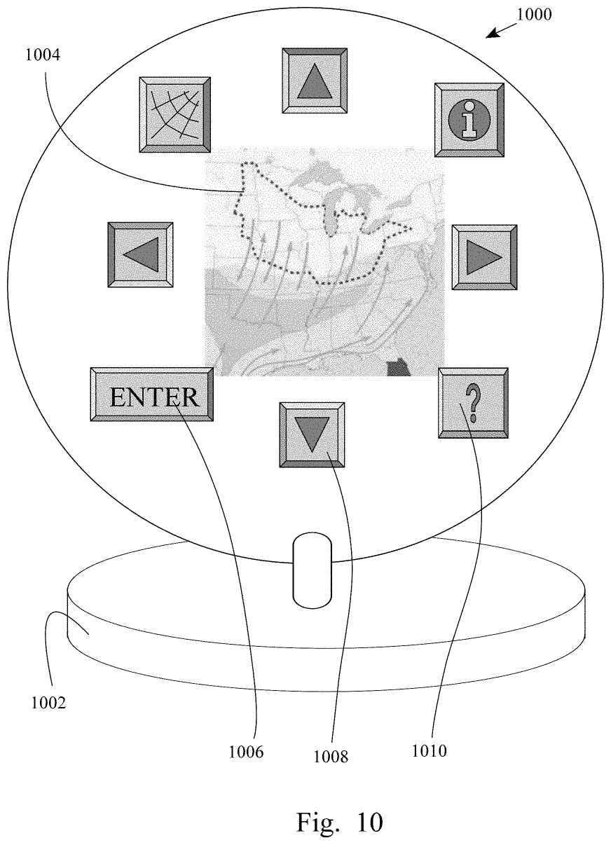

FIG. 10:
globe assistant 1000
Base 1002

Migration of the Eastern
Monarch Population 1004
Touch sensitive soft buttons 1006, 1008, 1010

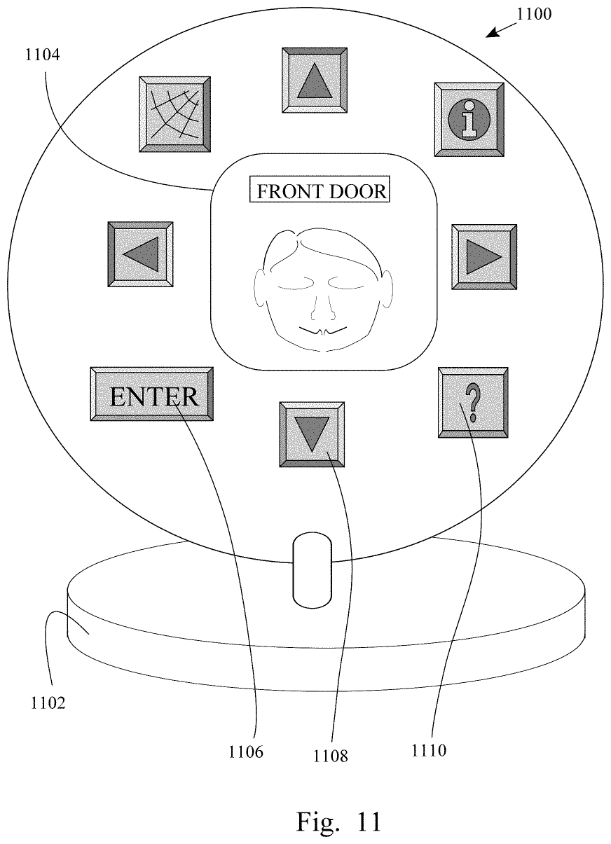

FIG. 11:

Voice controlled intelligent
personal assistant 1100
Base 1102
Front doorbell camera view app 1104
Touch sensitive soft buttons 1106, 1108, 1110

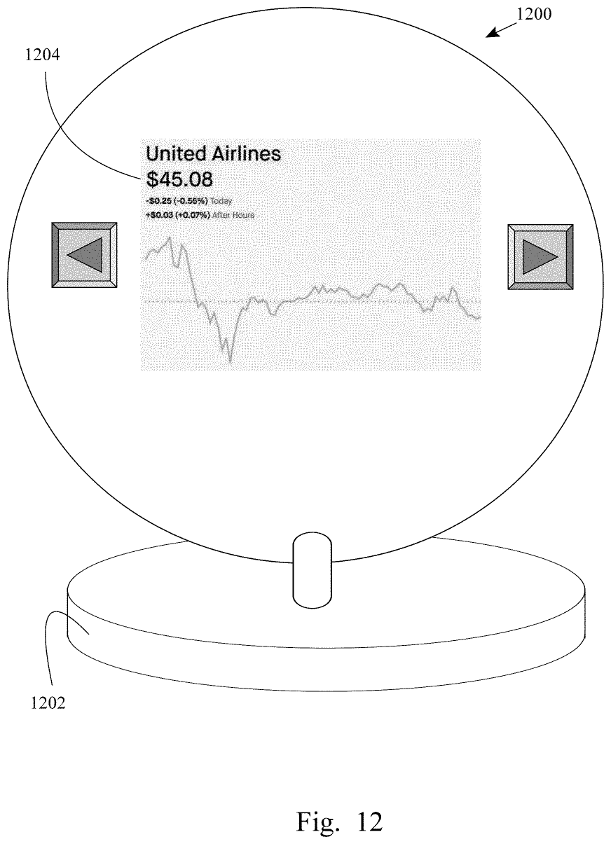

FIG. 12:

Voice controlled intelligent
personal assistant 1200
Base 1202
Financial trading app 1204

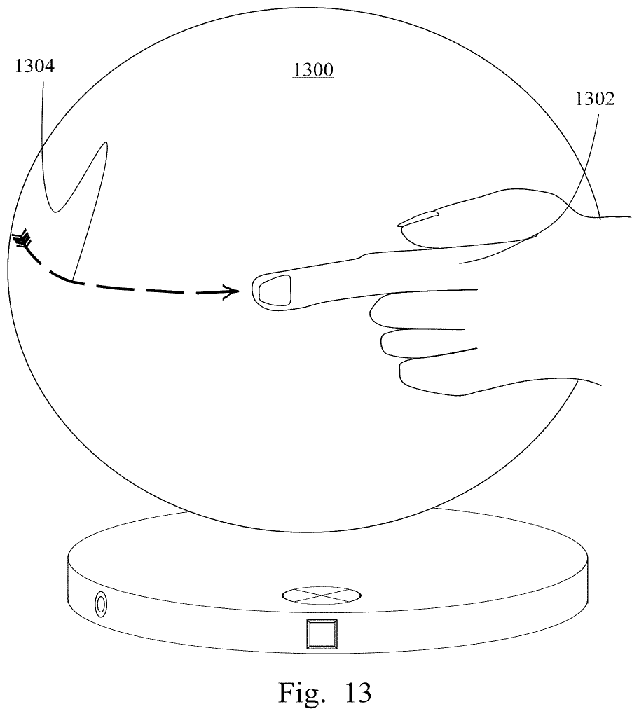

FIG. 13:

Voice controlled intelligent
personal assistant 1300
User finger 1302
Swipe gesture 1304

### DETAILED DESCRIPTION

### Glossary

As used herein a “high resolution” display is one which has a high pixel density, such as a Retina® display or the like. LED in this context means not only light emitting diodes but also other electronically activated displays of very high pixel density.

An electrical drive of high precision may be a stepper motor having the ability to turn precisely by an amount of less than 2 degrees ( 1/180 of a complete turn), and/or geared downward by means of gears, belts or other mechanical arrangements to provide extremely smooth and fine control over rotation of the globular shell of the invention.

AI refers to artificial intelligence. AI may be internal to the invention, or in the presently preferred embodiment and best mode now contemplated, it may be external AI located in a server/network (an “extelligence”).

Globe mode may refer to the device of the invention masquerading to a greater or lesser extent, as a globe, or to providing a globe background to other apps, or simply functioning as a globe.

### End Glossary

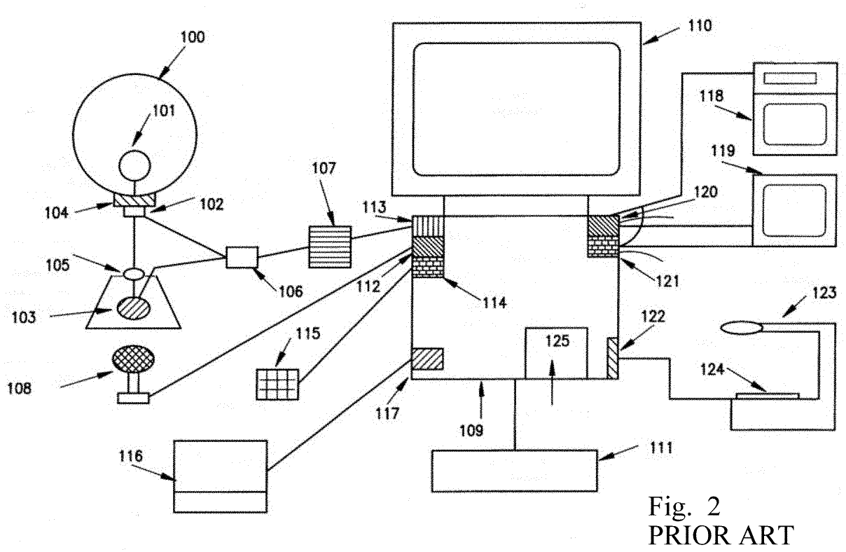

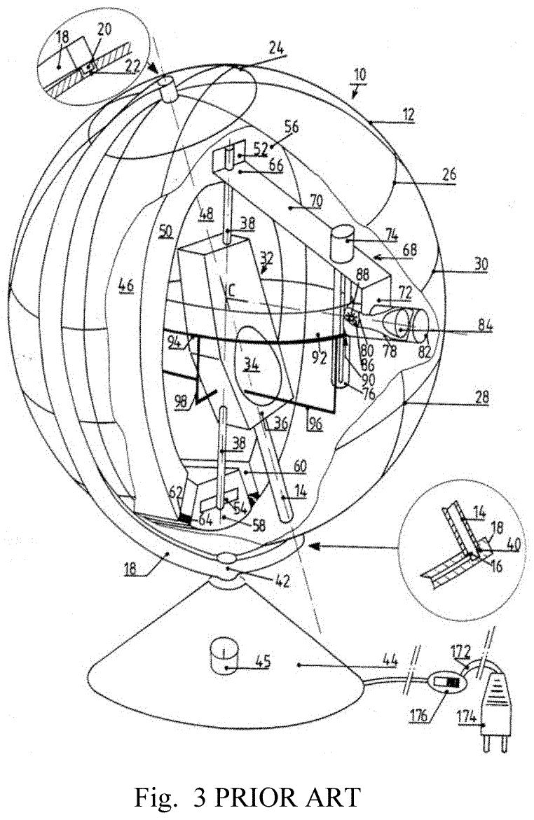

FIG. 1 is a PRIOR ART flat screen computer display mounted within some sort of globular housing and FIG. 2 is a PRIOR ART block diagram of a computer system with a globe style display as part of the overall system, while FIG. 3 is a PRIOR ART partially cross-sectional view of a reasonably complex device for globe displays. These are the best copies available, as it is prior art not associated in any way with the present applicant and acquired from the USPTO image database. These items are discussed above in the Background section of this application.

FIG. 4 is a view showing a default setting, one of many possible variant default settings, in which the virtual assistant is doubling as a globe with Australia displayed upon the invention, with additional features visible. Globular assistant 400 shows the user Australia 402. The globe may have been rotating (404) prior to that, or may have been virtually rotating, or even rotating the other direction.

Support 406 connects the globe shell 400 to a stand/base 408. The control circuitry may be in the base in this embodiment, with USB port 410 and a standard mini jack 412 projecting from a circuit board or on wiring from the circuit board. USB port 410 allows easy connection to networks such as the internet, which in turn allows use of an external AI (an extelligence) found on internet servers rather than within the invention itself. By allowing use of less circuitry, the connection to the external AI reduces the complexity and cost of manufacture of the invention. In addition, the virtual assistant “located” on a remote server computer may respond to voice commands from the user, or other commands from the user, by changing the operation of the spherical voice controlled intelligent personal assistant 400.

FIG. 5 is a cross-sectional view of the shell of the invention showing only the panels from the inside space within, with other components removed. The cross-sectioned spherical voice controlled intelligent personal assistant 500 has as its major component the shell 502. Within the shell 502 is an interior space 504.

The entire shell need not be a large spherical display. Instead it may be composed of joined, individual high quality display panels 506, 508, 510, etc, having a modest curvature. It may also be a shell with the high quality displays adhered to the outside, assuming that use of flexible panels becomes practical and economical in the future.

FIG. 6 is a block diagram in cross-section of the invention, with the other components still indicated. In FIG. 6 the cross-sectioned spherical voice controlled intelligent personal assistant 600 still has display shell 602 however the individual high quality display panels (for example 506, previous FIG. 5) are not shown for clarity.

Stepper motor 604 and drive mechanism 606 may be employed to allow the smart sphere to physically rotate. Obviously, it may as well also visually/virtually rotate by moving the displayed images, not moving the shell. Either option may be used and both have advantages.

Control circuitry 608 will be explained in greater detail in regard to FIG. 7. However, certain large features may be observed: speaker 610 allows the output of audio such as speech or music. Note that given the size of the globe portion of the intelligent assistant, even stereo is perfectly possible within the space of a single unit. (It may also have remote stereo speakers.) Wifi antenna 612 and Bluetooth® antenna 614 are unlikely to be as depicted but either or both allow wireless connection to other devices, such as networks, mobile devices, computers and so forth.

Microphones 616 (wiring omitted for clarity) may be spaced about, and located on the base, in order to allow better omnidirectional pickup of sound from users, in particular, voice commands and voice questions. Using a single microphone is also possible, by preventing the body of the spherical voice controlled intelligent personal assistant from blocking voices.

FIG. 7 is a block diagram of the electronic control circuitry and communication devices of the present invention. Mobile device 702, computer (PC or server) 704, network 706 and cellular network 708 may all connect to the invention by means of communication module 710, which may have both or either of a radio communication module 712 and a wired communication module 714.

Graphics controller 716 will naturally control the display on the high quality displays which cover the surface of the spherical voice controlled intelligent personal assistant. CPU/RAM 718 may be employed in embodiments to allow greater autonomous functionality, such as ease of connection, offline operations, data compression in voice recognition and so on and so forth.

Voice recognition/audio in 720 is used for voice control. Again, with autonomous processing capability the device may have internal voice recognition in some embodiments, while in other embodiments audio in may be sufficient as the audio may then be transmitted to an extelligence for voice recognition processing before the data acquisition and processing.

Precise optional stepper driver 722, as discussed previously, is capable of providing partial rotations to exact tolerances. By means of gearing, belts, and other mechanical advantage devices the actual rotation may be geared down even further. For example, a stepper motor able to provide 1.8 degree precision (stepping as little as 1.8 degrees, or ½ of 1% of a complete rotation) which had a mechanical disadvantage of 10 to 1, would allow rotation of the spherical voice controlled intelligent personal assistant by amounts as small as 0.18 degrees, that is, 1/20 of 1% of a complete rotation. This fine control will be necessary if optional mechanical rotation is desired, but of course embodiments may offer only virtual rotation by swiping or other gestural or vocal commands.

Sound output 724 will allow audio data delivery, very useful not just for busy people not looking at the spherical voice controlled intelligent personal assistant itself but also for the visually handicapped who happen to end up using the invention. Display(s) out 726 depict the block diagram of the physical displays seen in FIG. 5.

FIG. 8 is a globe view map of the maximum extent of the Mongol Empire c. 1400, with the extent marked on a contemporary view of the Earth. This view may be zoomed, although in this case it is a complete global view: the next two views show the effects of zooming. This view furthermore shows other features of the invention. Spherical voice controlled intelligent personal assistant 800 shows the user (with a user selected broken line) a map of the maximum extent of the Mongol Empire 802. The globe assistant 800 has a base mounted speaker 804 (and may have more than one, for stereo) and a base mounted transparent plastic hard button 806, indicating it is an embodiment with the circuitry either split between the globe and the base or the circuitry mostly in the base. Microphone 807 may be mounted in the base, as may camera 809. Note that camera 809 may assist with locating the user and orienting displays in the correct direction.

FIG. 9 is a zoom view, rather than globe view, of the drainage of the Mississippi River, expanded for maximum detail, and on an alternative embodiment of the invention which is suspended rather than supported from beneath. Spherical voice controlled intelligent personal assistant 900 has a suspension point 902 which has attached to it suspension 904, in this case a wire. This globe assistant 900 is hung rather than on a base. Zoomed map 906 of the Mississippi River drainage/watershed is clearly not in proportion to the entire planet, rather, the area of interest has been zoomed by the invention at the command of the user. This might be a two finger gesture, a voice command, a command from an app on a mobile device, etc. So, for example, in known prior art a zoom in may be accomplished by spreading two fingers and a zoom out by pinching. Pinching the view of the Mississippi River might reduce it as much as desired, even to a full global view (much like the full global view of the Mongol Empire of FIG. 8). Spreading the view might allow one to zoom in further and further until individual boats docked at Vicksburg might be in view.

To reiterate, the device is preferably voice and conversationally controlled as well, so a user could simply say, “Globy, zoom in on the Mississippi River basin. I have an assignment due. Zoom more. Zoom more.” And the device might respond with: “Janey, is this enough zoom?” “No, zoom one more time.” Such a conversation could reach whatever level of sophistication AI allows, and since the device may be a terminal which gains its abilities via network connections and network processing power, it's ability could be constantly upgrading without any local download or other upgrade.

FIG. 10 is a zoom view of the migration pattern of the eastern population of Monarch Butterflies, showing how the invention may also utilize touch control of the interface, display and so on. This view is orthographic to the viewer, so that for clarity the display appears to the user to be flat and round rather than spherical.

Notice that the buttons corners which are closest to the visual edge of the spherical voice controlled intelligent personal assistant should be (but are not) smeared and distorted by the curvature of the globe. If they were true spherical rectangles (a rectangle projected on the surface of a sphere, that is, the shape of the state of Wyoming for example) then the buttons would in fact be smeared, visually, unless viewed from directly over each individual button.

However, the spherical voice controlled intelligent personal assistant can use audio input from multiple microphones (see FIG. 6) to gain a general location of the user, through binaural or multiaural detection. It may also use a camera with facial recognition technology, not just for security or personalization but again, to orient a running app toward the user. Then the spherical voice controlled intelligent personal assistant can enlarge the “smeared” portions of buttons until they present the appearance of being true (non-spherical) rectangles, more or less with one corner anchored to the surface of the globular shell of the personal assistant and the rest flat and rising above it: an illusion only, the illusion due to removing any sense of three dimensional depth or curvature.

As noted previously, it is believed that the best mode as presently contemplated is voice input and output.

Globe assistant 1000 still has base 1002. In the present mode of an orthographic projection, the map of the migration of the Eastern Population of the Monarch Butterfly 1004 is centered toward the user. Surrounding it are various buttons for standard operations of different types. Touch sensitive soft buttons 1006, 1008, 1010 are projections on the touch sensitive high resolution displays, distorted as explained previously in order to appear not distorted. Note that given the ability of a touch sensitive shell to “swipe”, the use of arrow keys, like the use of other keys, an “on-globe” keyboard and so forth, might be customized by the user. Multi-touch commands such as “pinch”, etc. may be supported, in which case old school soft buttons may be entirely eliminated.

FIG. 11 essentially gets away from the default globe related uses of the invention and focuses on the ability of the voice controlled intelligent personal assistant 1100 to run legacy apps which simply use a portion of the screen for known purposes such as video conferencing.

Base 1102 is as discussed, while the smart spherical part of the invention is displaying a video conference with a front doorbell camera view app 1104. Touch sensitive soft buttons 1106, 1108, 1110 are as discussed previously.

FIG. 12 shows the voice controlled intelligent personal assistant 1200 used in an even more “legacy” mode than FIG. 11; in FIG. 12 it is actually showing a more or less browser based (server provided) view from what appears to be a financial trading platform, that is, the device is functioning to “surf the internet” to provide its present app usage. Again, base 1202 is as described previously.

Note that this embodiment shows the use of multi-touch control (“pinch”, “swipe”, “spread”, “tap” and so forth) so the soft buttons are either eliminated or greatly reduced.

The device may communicate with other smart devices such as tablets, other assistants, thermostats, refrigerators, and so forth, and may synch to all of these devices or to a desktop or laptop computer. Again, it may work with legacy apps such as those for Apple or Android operating systems.

FIG. 13 is a view of an embodiment of the invention with no support post depicted and a user engaged in a swipe gesture, from left to right.

The voice controlled intelligent personal assistant 1300 is in use, and the user is electing not to use voice control but instead is swiping. (Obviously just because the device can display soft buttons, or use gesture control as in this example, does not mean that it is not voice controllable as well.)

User finger 1302 is seen moving from left to right (as seen from reader view). The swipe gesture 1304 is depicted by a broken arrow representing where the fingertip has been and is moving.

This gesture might be intended for any purpose depending on the application in use. As a partial and strictly exemplary listing, this might be a character control in a game app, it might be a rotation command in a “globe” view, it might move a map sideways in a mapping application, it might increase or decrease the volume of the voice from the speakers of the invention, or increase or decrease music volume, or it might fast forward a video playback, and so forth.

The disclosure is provided to render practicable the invention by those skilled in the art without undue experimentation, including the best mode presently contemplated and the presently preferred embodiment. Nothing in this disclosure is to be taken to limit the scope of the invention, which is susceptible to numerous alterations, equivalents and substitutions without departing from the scope and spirit of the invention. The scope of the invention is to be understood from the appended claims.

Methods and components are described herein. However, methods and components similar or equivalent to those described herein can be also used to obtain variations of the present invention. The materials, articles, components, methods, and examples are illustrative only and not intended to be limiting.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art.

Having illustrated and described the principles of the invention in exemplary embodiments, it should be apparent to those skilled in the art that the described examples are illustrative embodiments and can be modified in arrangement and detail without departing from such principles. Techniques from any of the examples can be incorporated into one or more of any of the other examples. It is intended that the specification and examples be considered as exemplary only, with a true scope and spirit of the invention being indicated by the following claims.

What is claimed is:

1. A virtual personal assistant, voice controlled and in the shape of a globe, the virtual personal assistant comprising:
a globular shell having a curved surface;
a support, the globular shell mechanically held by the support;
the globular shell comprising at least one high resolution LED panel conforming to the curved surface of the globular shell;
a control circuit operative to control the high resolution LED panel, the control circuit also operative to carry out voice recognition, the control circuit responsive to voice recognition;
an external communication connection operative to allow communication from outside the globular shell.

2. The virtual personal assistant of claim 1, further comprising:
a second high resolution LED panel, in which the two high resolution LED panels are curved to match the curved surface of the globular shell.

3. The virtual personal assistant of claim 1, further comprising:
a second high resolution LED panel, in which the two high resolution LED panels are flexible, and adhered to the curved surface of the globular shell.

4. The virtual personal assistant of claim 2, further comprising:
an electrically operated drive mechanism, the electrically operated drive mechanism including a stepper motor operative to respond to commands from the control circuit and rotate the globular shell precisely.

5. The virtual personal assistant of claim 4, wherein the support further comprises:
a base disposed beneath the globular shell, the base connected to the globular shell by an axis allowing the precise rotation of the globular shell.

6. The virtual personal assistant of claim 4, wherein the support further comprises:
a suspension system disposed above the globular shell, the suspension system comprising a rotatable connection to the globular shell allowing precise rotation of the globular shell and a thin resilient member in turn connected to the rotatable connection.

7. The virtual personal assistant of claim 5, wherein the external communication connection further comprises:
an RF communication module operative to communicate via wife.

8. The virtual personal assistant of claim 7, wherein the external communication connection further comprises:
an RF communication module operative to communicate via Bluetooth.

9. The virtual personal assistant of claim 8, wherein the external communication connection further comprises:
an RF communication module operative to communicate via cellular telephone network.

10. The virtual personal assistant of claim 8, wherein the external communication connection further comprises:
a wired USB communication port.

11. The virtual personal assistant of claim 8, wherein the external communication connection further comprises:
a wired Lightning communication port.

12. The virtual personal assistant of claim 8, wherein the external communication connection further comprises:
a wired ethernet communication port.

13. The virtual personal assistant of claim 8, wherein the external communication connection further comprises:
a wired stereo mini-jack output port.

14. The virtual personal assistant of claim 10, wherein the control circuit further is operative to charge the globular shell via USB charging.

15. The virtual personal assistant of claim 10, wherein the control circuit further is operative to power the globular shell via USB.

16. The virtual personal assistant of claim 14, wherein the control circuit further is operative to receive commands from a mobile device, the mobile device having a CPU and memory;
a virtual personal assistant control app residing in the memory of the mobile device.

17. The virtual personal assistant of claim 14, wherein the control circuit further is operative to receive commands from a computer, the computer having a CPU and memory;
a virtual personal assistant control app residing in the memory of the computer.

18. The virtual personal assistant of claim 16, wherein the control circuit further is operative to receive commands from the computer remotely via a network.

19. The virtual personal assistant of claim 14, wherein the control circuit further is operative to access a network in response to the voice recognition.

20. The virtual personal assistant of claim 18, wherein the control circuit is further operative to display upon the high resolution LED panels a plurality of soft buttons;
and wherein the high resolution LED panels are touch sensitive and operative to detect activation of a first one of the plurality of soft buttons;
and further wherein the control circuit is operative to respond to activation of the first one of the soft buttons.

21. The virtual personal assistant of claim 1, further comprising:
a microphone;
a speaker;
wherein the virtual personal assistant is operative to respond to voice queries and voice commands using voice output and visual display output.

22. An electronic personal assistant for use with a network, the electronic personal assistant comprising:
a globular shell having a curved surface;
a support, the globular shell mechanically held by the support so that it may rotate freely upon the support;
the globular shell comprising a plurality of high resolution touch sensitive LED panels conforming to the curved surface of the globular shell;
a control circuit operative to control the high resolution LED panels, the control circuit also operative to carry out voice recognition, the control circuit responsive to voice recognition, the control circuit further operative to display on the high resolution LED panels a plurality of soft buttons, the high resolution LED panels operative to detect activation of a first one of the plurality of soft buttons, the control circuit is operative to respond to activation of the first one of the soft buttons;
an external communication connection operative to allow communication from outside the globular shell, the external communication connection having an RF communication module operative to communicate via Bluetooth and wife, the external communication connection further having a wired USB port, the control circuit operative to power the electronic personal assistant via USB, the control circuit further operative to access such network in response to voice recognition;
an electrically operated drive mechanism, the electrically operated drive mechanism including a stepper motor operative to respond to commands from the control circuit and rotate the globular shell precisely;
a base disposed beneath the globular shell, the base connected to the globular shell by an axis allowing the precise rotation of the globular shell.
